(19) United States
(12) Patent Application Publication
(10) Pub. No.: US 2019/0287099 A1
(43) Pub. Date: Sep. 19, 2019

(54) DISTRIBUTED LEDGER UPDATE METHOD

(71) Applicant: JAMES TAN, SINGAPORE (SG)

(72) Inventor: JAMES TAN, SINGAPORE (SG)

(21) Appl. No.: 15/924,234

(22) Filed: Mar. 18, 2018

(51) Int. Cl. G06Q 20/38; H04L 9/06; G06F 16/23; G06Q 20/06

(52) U.S. Cl. CPC G06Q 20/389; H04L 9/0637; H04L 9/0643; G06F 16/2379; G06Q 2220/00; G06Q 20/065; H04L 2209/56; H04L 2209/38; G06Q 20/3827

(57) ABSTRACT

In this disclosure, a method for the update of a distributed ledger of a cryptocurrency is presented whereby transaction data need only be broadcasted once in the cryptocurrency network, thereby reducing the bandwidth consumption of the consensus nodes in the network. This is achieved with a two-stage process where in the first stage, a consensus is reached on the transactions that were received from every consensus node in the network. In the second stage, each consensus node uses an identical predefined protocol to obtain a subset of transactions from the total set reached in the first stage, with the predefined protocol being any systematic and deterministic way of obtaining the subset of transactions that are valid such that no cryptocurrency address is overdrawn. A consensus is then reached by the network on the state of the updated ledger after inclusion of this subset of transactions in the distributed ledger.

### FIELD OF THE INVENTION

The invention pertains to cryptocurrencies, more specifically, the invention pertains to the method of updating a distributed ledger.

### BACKGROUND OF THE INVENTION

Satoshi Nakamoto's invention of the blockchain secured with Proof-of-Work (PoW) allowed the consensus of a distributed ledger among its users. As the distributed ledger is updated with transactions, cryptocurrency users can securely reach a consensus on a single and up-to-date version of the distributed ledger. With PoW, the consensus mechanism is Byzantine Fault Tolerant (BFT). This ensures a certain degree of security against Byzantine faults due to malicious actors or malfunctioning equipment.

Consensus on the distributed ledger may also be achieved by more conventional BFT algorithms among nodes in the cryptocurrency network. An example of such an algorithm is the well-known Practical BFT (PBFT) introduced by Castro and Liskov in 1999. Henceforth, nodes that participate in the consensus of the distributed ledger shall be known as consensus nodes while network or cryptocurrency network shall refer to the network of consensus nodes. We also define an epoch to represent an update to the distributed ledger. The time period associated with an epoch is defined as a cycle. A simple scheme to update a distributed ledger is to achieve consensus via a BFT algorithm on every transaction that is proposed to be added to the distributed ledger. However, in a typical BFT algorithm, consensus nodes would have to go through at least three phases of communication with each other. Hence, such a scheme would severely limit the throughput (measured in terms of transactions processed per second) of the cryptocurrency network because consensus nodes in cryptocurrency networks typically communicate with each other over the internet. The time it takes to reach a consensus on one transaction depends on the internet latency between the consensus nodes over multiple phases of communication. This would limit the number of transactions that the network is able to process to a few transactions a second.

Another scheme that is used by some cryptocurrencies is to achieve consensus on blocks of transactions. In this way, internet latency becomes less of an issue since the BFT consensus algorithm is not run individually for every transaction. However, data for each transaction would still have to be broadcasted throughout the network at least twice before a consensus can be reached to include or reject the transaction from modifying the distributed ledger. Once to communicate the transaction to all consensus nodes in the network, and once when the transaction is included in the block and the block is communicated to all consensus nodes at the start of the BFT consensus process.

### SUMMARY OF THE INVENTION

In a high-throughput cryptocurrency, broadcasting every transaction twice can be inefficient and present a strain on the bandwidth capacity of consensus nodes. In this patent disclosure, a method for the update of a distributed ledger is presented such that a transaction would only have to be broadcasted once throughout the cryptocurrency network.

To achieve this, the update of the distributed ledger is broken into two parts. In the first part, consensus is reached for each consensus node on the cryptographic hash generated from transactions received from that consensus node. It is not necessary to reach consensus for each consensus node sequentially. Instead, consensus can be reached concurrently on the set of cryptographic hashes belonging to the consensus nodes. In the second part, each consensus nodes will obtain, using an identical predefined protocol, a subset of transactions from the total set of transactions reached in the first part. The predefined protocol is any systematic and deterministic way of obtaining the subset of transactions that are valid such that no cryptocurrency address is overdrawn. A consensus is then reached on the updated state of the distributed ledger obtained from inclusion of this subset of transactions into the current distributed ledger, with the updated state of the distributed ledger being represented by its cryptographic hash.

In the first part where, in the presence of considerable network latency such that a consensus cannot be reached regarding the set of transactions that were received from any consensus node, the consensus is retried for n times (where n is a non-negative integer) so as to allow time for consensus nodes to fully transmit and receive transactions before another consensus is attempted. If no consensus can still be reached, a last round of consensus would be conducted to ascribe a null set of transactions to that consensus node. This is done for all such consensus nodes concurrently.

### BRIEF DESCRIPTION OF THE DRAWINGS

FIG. 1 is an example of a cryptocurrency network;

FIG. 2 is a flowchart of the types of processes concurrently executed by a consensus node in implementing the example embodiment;

FIG. 3 is a flowchart of the processing of a transaction received by a consensus node;

FIG. 4 is a flowchart of the processing, by a consensus node, of broadcasted transactions from another consensus node; and

FIG. 5 is a flowchart of the consensus processes that a consensus node undertakes with the network in order to arrive at an update to the distributed ledger.

It should be noted that the figures contained herein illustrate various embodiments of the invention. One skilled in the art may come up with alternative embodiments that do not depart from the principles of the invention presented herein.

### DETAILED DESCRIPTION OF AN EXAMPLE EMBODIMENT

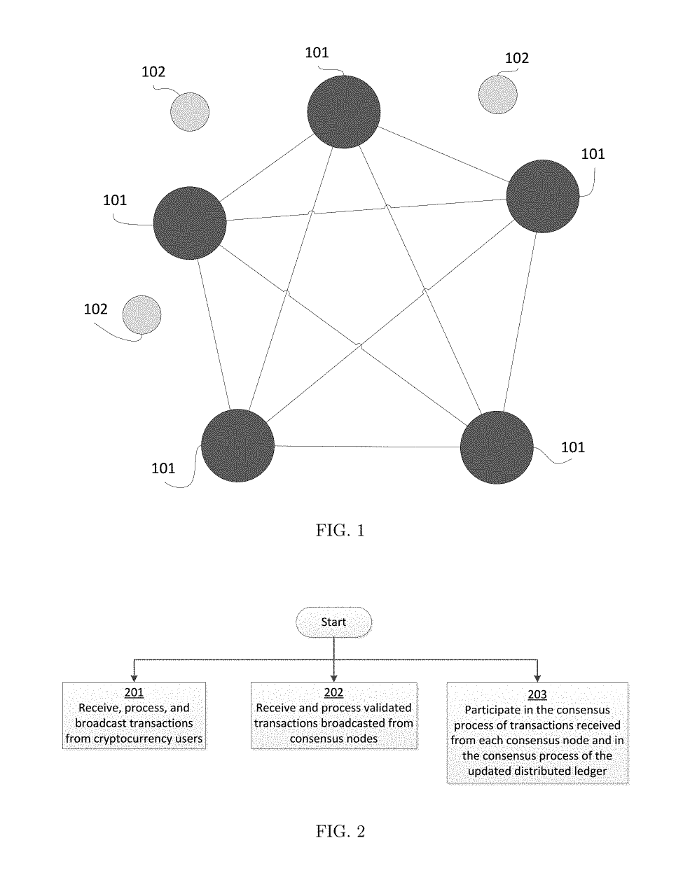

A detailed description of an example embodiment of the present invention is given hereinafter with reference to FIG. 1 and FIG. 2.

FIG. 1. shows a network diagram of an example embodiment of a cryptocurrency network. The network consists of five consensus nodes 101 in a fully connected configuration over the internet. These consensus nodes 101 may represent individual computers or computer clusters. Cryptocurrency users 102 that are not consensus nodes and who wish to include their transactions in the distributed ledger may communicate their transactions to any of the consensus nodes 101.

The fully connected configuration allows the consensus nodes 101 to transfer and receive messages in as little time as possible since no relay of messages is needed. It is also a resilient configuration but these advantages come at the expense of each consensus node having to maintain a large number of connections (i.e. connections to every other consensus node in the network).

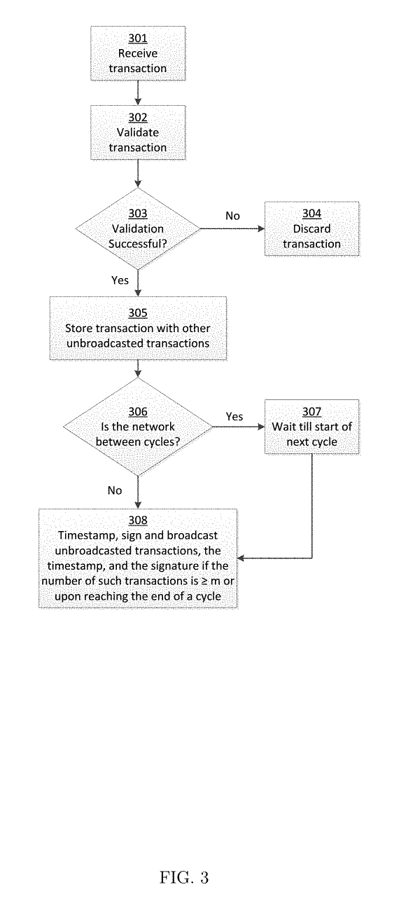

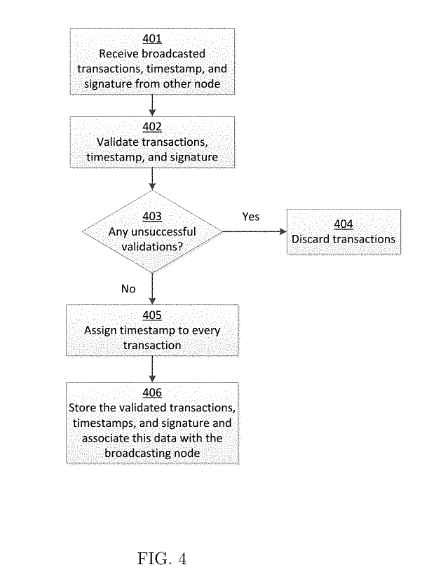

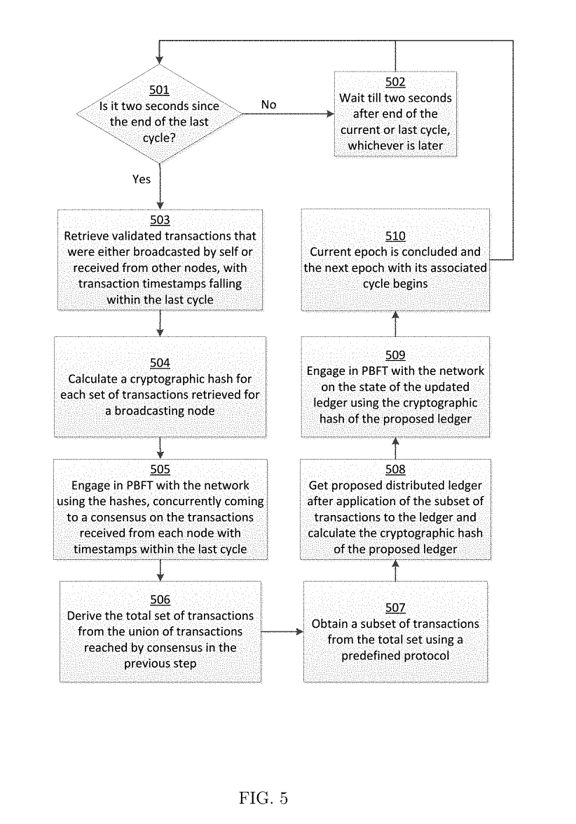

FIG. 2. shows the flowchart of the types of processes undertaken by each consensus node in order for the network to update the distributed ledger. Three types of processes (201, 202, and 203) are run concurrently and their respective flowcharts are shown in FIG. 3, FIG. 4, and FIG. 5. In this example embodiment, a cycle of an epoch starts immediately after the conclusion of the previous epoch and lasts for five seconds. Any cryptocurrency user 102 who wishes to include a transaction in an epoch sends his/her transaction to any of the consensus nodes 101. The transaction must contain a cryptographic signature corresponding to the sender's cryptocurrency address. The signature authorizes the part of the transaction describing the transfer of cryptocurrency funds from the sender's cryptocurrency address to the receiver's cryptocurrency address.

The process undertaken 201 by the receiving consensus node of a transaction is shown in FIG. 3. Upon receiving the transaction 301, the receiving consensus node validates the transaction 302, verifying that the signature is correct, the sender's cryptocurrency address contains sufficient funds for the transaction, and that the sender is not reusing an old transaction. Next, the validation outcome is accessed 303. If the validation is not successful, the transaction is discarded 304. If the validation is successful, the consensus node will store the transaction 305 and check whether a not the network is currently between cycles 306. If the network is in a cycle 308, the consensus node will timestamp the group of all stored and unbroadcasted transactions, sign this group of transactions, and broadcast these transactions, the timestamp, and the signature to the rest of the network if there are at least m (with m a positive integer) such transactions. If the number of such transactions is less than m, the consensus node will wait until the end of the cycle before timestamping, signing, and broadcasting all stored and unbroadcasted transactions. If the network is between cycles 307, the consensus node will first wait until the start of the next cycle before proceeding with the same steps.

Each consensus node, upon receiving a group of validated transactions and its attendant timestamp and signature from another consensus node, undergoes the same operation 202 to process validated transactions received from other consensus nodes as described in FIG. 4. Upon receiving the transactions, timestamp, and signature 401, the receiving consensus node will perform the same validations as the broadcasting consensus node on the group of transactions 402, additionally verifying that the timestamp is earlier than the time at which the transactions and signature were received, verifying that the timestamp is not earlier than the start of the last cycle or the current cycle (if the network is in a cycle), verifying that the timestamp is not later than the end of the last cycle if the network is not in a cycle, and verifying that the signature from the broadcasting consensus node is correct. Next, the validation outcomes are accessed 403. If there is any unsuccessful validation, the transactions are discarded 404. If all validations are successful, the timestamp is assigned to every transaction 405. The validated transactions are then stored along with their timestamp and signature and this data is associated with the broadcasting node 406.

The third type of process 203 that a consensus node will undergo is for the network to reach a consensus on the transactions received from each node and for the network to reach a consensus on the state of the updated distributed ledger. Two seconds after the end of a cycle (501 and 502), each consensus node y will generate a cryptographic hash for every consensus node x in the network including itself, where the cryptographic hash that is generated by consensus node y for consensus node x is generated from the transactions that were received by y from x with timestamps lying within the most recent cycle, or in the case where consensus node y is generating the cryptographic hash for itself (i.e. y is x), the transactions that were broadcasted by y with timestamps lying within the most recent cycle (503 and 504).

In order to conclude the epoch, the consensus nodes of the network must first reach a consensus on the transactions that have been received from each consensus node 505, with the transactions being represented by the cryptographic hashes generated from before. Consensus can be achieved by the Practical Byzantine Fault Tolerance algorithm (PBFT) introduced by Castro and Liskov in 1999. Instead of achieving consensus sequentially for each consensus node, the consensus on the transactions received by the network for each consensus node can be done concurrently since the transactions that were received from one node has no effect on the transactions that were received from a different node. In the case where consensus cannot be reached for any consensus node, another consensus is reached to assign a null set of transactions to that consensus node for all such consensus nodes concurrently.

After consensus has been reached on the transactions that were received from each consensus node, each consensus node will compute the union of these transactions that were reached by consensus which gives the total set of transactions to be processed by the network for the current epoch 506. An identical predefined protocol is used by each consensus node to retrieve a subset of transactions from the total set of transactions 507, after which a cryptographic hash is calculated from the proposed updated ledger obtained from the application of this subset of transactions to the current state of the distributed ledger 508. The predefined protocol is any systematic and deterministic way of obtaining the subset of transactions that are valid such that no cryptocurrency address is overdrawn. Another consensus is then reached by the network on the updated state of the distributed ledger represented by the cryptographic hashes that were just generated by all the consensus nodes 509. PBFT can also be used for this consensus process.

Once consensus on the updated state of the distributed ledger has been reached, the current epoch is concluded and the next epoch with its associated cycle begins 510.

What is claimed:

1. A method for the update of a distributed ledger comprising the steps of:
a) validating according to a predefined validation protocol, by each consensus node of the network, transactions that have been communicated to it that are not part of a broadcast;
b) broadcasting to the other consensus nodes of the network, by each consensus node in the network, of transactions communicated to it and that have been validated by it;
c) creating, by each consensus node y of the network, a cryptographic hash for every consensus node x in the network in which the cryptographic hash being generated uses as input, data comprising a subset of transactions from the set of validated transactions broadcasted and received from the consensus node x by the consensus node y, or, in the case where the consensus node is generating the cryptographic hash for itself (i.e. x=y), a subset of transactions from the set of validated transactions broadcasted by the consensus node x generating the cryptographic hash;
d) reaching a consensus on the hash generated from the previous step for each consensus node x, by all consensus nodes of the network through the use of a BFT algorithm, where in the case of a failure to reach a consensus on any particular hash representing a particular set of transactions for consensus node x, the consensus is retried for n (where n is a non-negative integer) number of times before a consensus is reached to ascribe a null set of transactions for consensus node x;
e) determining using a predefined protocol, by each consensus node of the network, a proposed subset of transactions to include for an epoch from the total set of transactions reached by consensus from the previous steps c) and d), the total set of transactions being the union of the sets of transactions that were reached by consensus for each consensus node in steps c) and d);
f) creating, by each consensus node of the network, a cryptographic hash from data comprising the proposed subset of transactions to include or the updated state of the distributed ledger upon inclusion of the proposed subset of transactions or both; and
g) reaching a consensus, by all consensus nodes of the network through the use of a BFT algorithm, on the state of the distributed ledger at the conclusion of the current epoch where the state of the distributed ledger is represented by the hash from the previous step.

2. The method of claim 1 wherein an epoch represents an update to the distributed ledger.

3. The method of claim 2 wherein a consensus node is any node that participates in the consensus of the state of the distributed ledger.

4. The method of claim 3 wherein the predefined protocol used by consensus nodes in step a) is identical across consensus nodes.

5. The method of claim 4 wherein the predefined protocol in step e) refers to any systematic and deterministic method that produces a subset of transactions that are valid such that no cryptocurrency address is overdrawn.

6. The method of claim 5 wherein the predefined protocol used by consensus nodes in step e) is identical across consensus nodes.

7. The method of claim 6 wherein a transaction comprises instructions for one or more transfers of cryptocurrency funds between cryptocurrency addresses, or instructions leading to one or more transfers of cryptocurrency funds between cryptocurrency addresses, or both;

8. The method of claim 7 wherein the subset of transactions for each consensus node x in step c) refers to transactions selected from a group comprising at least one of the following: validated transactions received from consensus node x during a specified timeframe corresponding to the epoch, validated transactions that were timestamped by consensus node x with the timestamp falling within a specified timeframe corresponding to the epoch, and validated transactions that were timestamped by the sending party of the funds of the transaction with the timestamp falling within a specified timeframe corresponding to the epoch.

9. The method of claim 8 wherein the consensus that is reached for every consensus node x in step d) is achieved for all consensus nodes concurrently (as opposed to sequentially).

10. The method of claim 9 wherein, in the case where consensus cannot be reached on the cryptographic hash representing transactions received from any particular consensus node in step d), the consensus that is reached for that consensus node to ascribe a null set of transactions to it is achieved for all such consensus nodes concurrently (as opposed to sequentially).
